(19) United States
(12) Patent Application Publication
(10) Pub. No.: US 2012/0227641 A1
(43) Pub. Date: Sep. 13, 2012

(54) ROTATING APPARATUS

(75) Inventor: Kuo-Ming Tseng, Hsinchu (TW)

(73) Assignee: CORETRONIC DISPLAY SOLUTION CORPORATION, Hsinchu (TW)

(21) Appl. No.: 13/045,548

(22) Filed: Mar. 11, 2011

(51) Int. Cl. A47B 11/00; F16D 1/00

(52) U.S. Cl. 108/139; 403/164; 403/112

(57) ABSTRACT

A rotating apparatus including a base and a rotating element is provided. The base has first and second concave spherical surfaces. The rotating element includes first and second universally-jointing portions. The first universally-jointing portion has a first convex spherical surface. The first convex spherical surface is universally jointed to the first concave spherical surface. The second universally-jointing portion is fixed on the bottom of the first universally-jointing portion and has a second convex spherical surface. A curvature radius of the second convex spherical surface is smaller than a curvature radius of the first convex spherical surface. The first and second convex spherical surfaces have the same curvature center. The second convex spherical surface is universally jointed to the second concave spherical surface and the rotating element is supported on the second concave spherical surface of the base by the second universally-jointing portion.

### BACKGROUND OF THE INVENTION

1. Field of the Invention

The invention relates to a rotating apparatus and more particularly, to a rotating apparatus suitable to load a testing platform.

2. Description of Related Art

A medical ultrasound has advantages such as safety and low cost. Thus, medical ultrasounds are widely used during clinical diagnosis, for example, heart, abdomen, and maternity ultrasound check ups. In addition, the medical ultrasound may be further used for different medical experiments.

For example, the medical ultrasound may be used on an experimental living body (i.e. mouse) for image scanning. The user may dispose the testing platform holding the mouse on a rotating apparatus, rotate the mouse body with the rotating apparatus, and proceed with ultrasound scanning on different parts of the mouse. In detail, the rotating apparatus may have a base with a spherical slot, and is assembled by universally-jointing with the spherical structure of the spherical slot. The testing platform is rotated using the rotation of the spherical structure relative to the spherical slot. In order to allow the rotating apparatus to have enough rotating range, and allow the rotating apparatus to be suitable to support the testing platform, the spherical slot and the spherical structure need to have enough volume. However, if the rotating apparatus has too great a volume, it will require a greater production cost and occupies a larger space.

Taiwan patent no. 200914751 discloses a ball and a socket using a universal joint to rotate and support a load.

### SUMMARY OF THE INVENTION

The invention provides a rotating apparatus with a smaller volume.

Other objects and advantages of the invention may be further illustrated by the technical features broadly embodied and described as follows.

In order to achieve one or a portion of or all of the objects or other objects, one embodiment of the invention is directed to a rotating apparatus, including a base and a rotating element. The base includes a first concave spherical surface and a second concave spherical surface. The rotating element includes a first universally-jointing portion and a second universally-jointing portion. The first universally-jointing portion includes a first convex spherical surface. The first universally-jointing portion is universally jointed to the first concave spherical surface through the first convex spherical surface. The second universally-jointing portion is fixed on the bottom of the first universally-jointing portion and has a second convex spherical surface. A curvature radius of the second convex spherical surface is smaller than a curvature radius of the first convex spherical surface. The first convex spherical surface and the second convex spherical surface have the same curvature center. The second universally-jointing portion is universally jointed to the second concave spherical surface through the second convex spherical surface and supports the rotating element on the second concave spherical surface of the base.

Based on the above, in the embodiment of the invention, besides the rotating element being universally jointed to the base through the first universally-jointing portion, it is further universally jointed to the base through the second universally-jointing portion fixed on the bottom of the first universally-jointing portion, wherein the curvature radius of the second convex spherical surface of the second universally-jointing portion is smaller than the curvature radius of the first convex spherical surface of the first universally-jointing portion, so the second universally-jointing portion has a smaller outer diameter. Since the rotating element is supported on the base by the second universally-jointing portion, thus the first universally-jointing portion with a bigger outer diameter does not need to provide a function for supporting the rotating element, and so the first convex spherical surface does not need to be designed to extend to the bottom of the first universally-jointing portion. As such, the height of the first universally-jointing portion may be reduced, further reducing the overall volume, thereby saving production cost and space.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a three-dimensional view of part of the components of a rotating apparatus of an embodiment of the invention.

FIG. 2 is an exploded view of the rotating apparatus depicted in FIG. 1.

FIG. 3 is a cross-sectional view of the rotating apparatus depicted in FIG. 1.

FIG. 4 is a cross-sectional view of part of the components of a rotating apparatus of another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

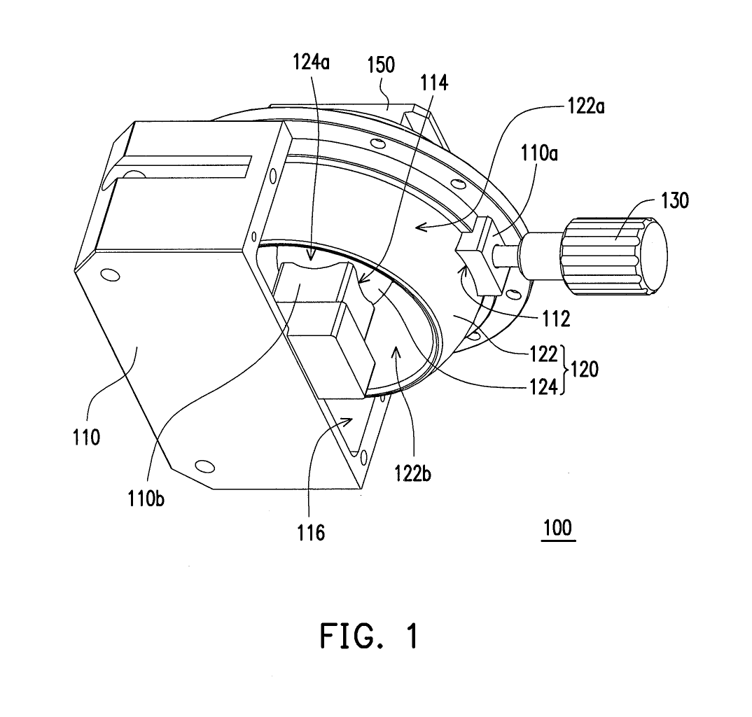

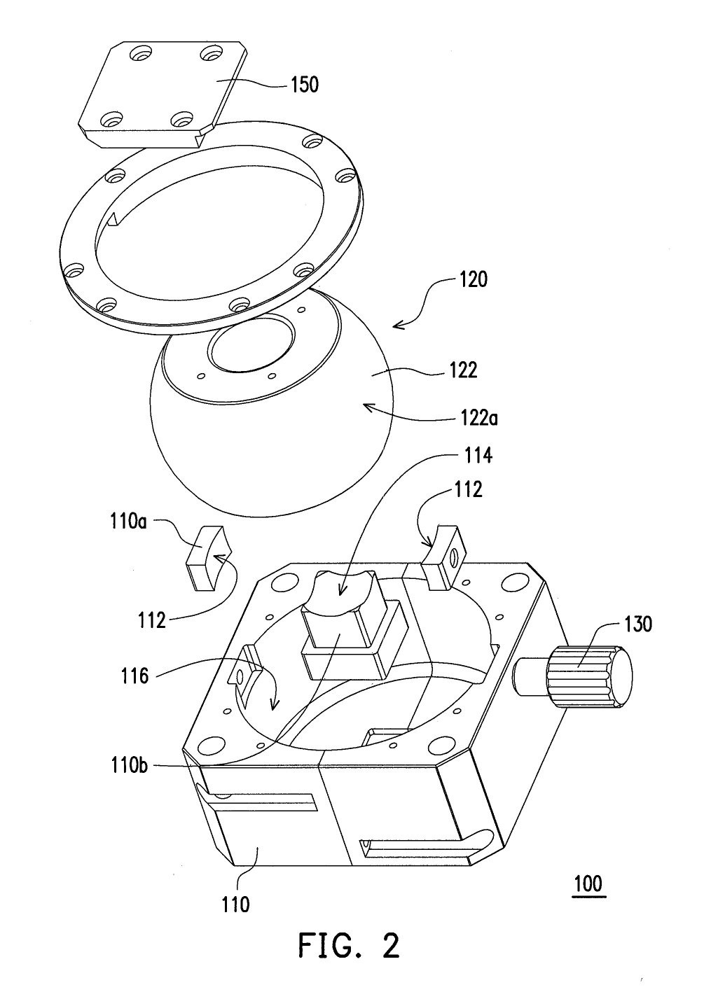

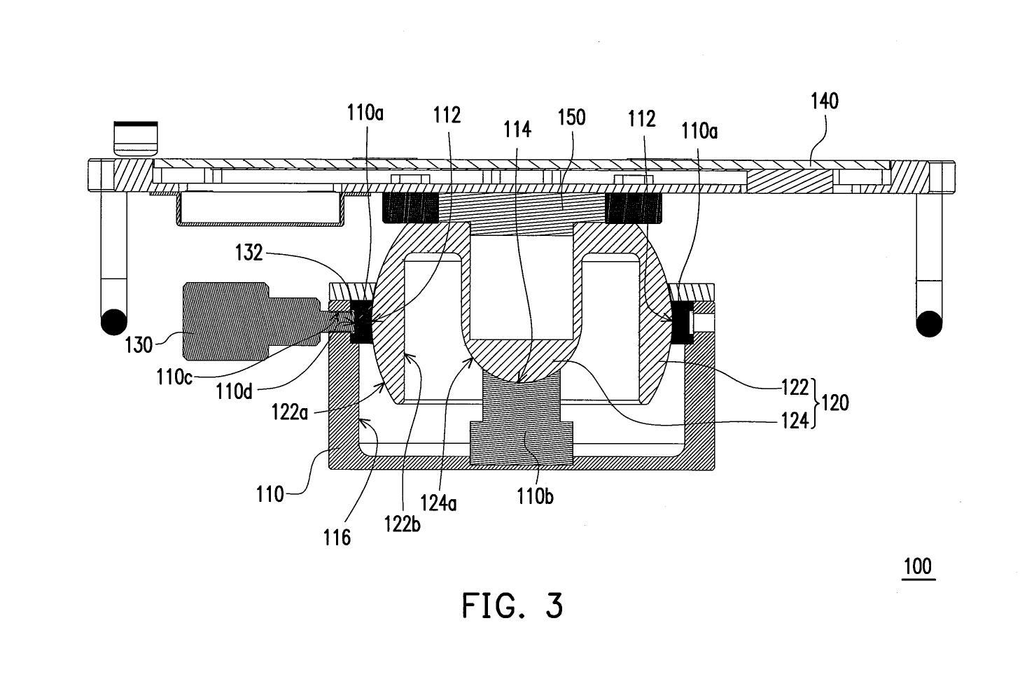

FIG. 1 is a three-dimensional view of part of the components of a rotating apparatus of an embodiment of the invention. FIG. 2 is an exploded view of the rotating apparatus depicted in FIG. 1. FIG. 3 is a cross-sectional view of the rotating apparatus depicted in FIG. 1. Referring to FIGS. 1 through 3, a rotating apparatus 100 includes a base 110 and a rotating element 120. The base 110 includes a first concave spherical surface 112 and a second concave spherical surface 114. The rotating element 120 includes a first universally-jointing portion 122 and a second universally-jointing portion 124, and is universally jointed to the base 110 through the first universally-jointing portion 122 and the second universally-jointing portion 124.

In detail, the first universally-jointing portion 122 has a first convex spherical surface 122a. The second universally-jointing portion 124 is fixed to the bottom of the first universally-jointing portion 122 and has a second convex spherical surface 124a. The first universally-jointing portion 122 is universally jointed to the first concave spherical surface 112 of the base 110 through the first convex spherical surface 122a. The second universally-jointing portion 124 is universally jointed to the second concave spherical surface 114 of the base 110 through the second convex spherical surface 124a, and supports the rotating element 120 on the second concave spherical surface 114 of the base 110. In the above design, the first convex spherical surface 122a of the first universally-jointing portion 122 and the second convex spherical surface 124a of the second universally-jointing portion 124 are designed to have the same curvature center, so the first universally-jointing portion 122 and the second universally-jointing portion 124 are suitable to rotate relative to the base 110 at the same time.

In addition, a curvature radius of the second convex spherical surface 124a of the second universally-jointing portion 124 is smaller than a curvature radius of the first convex spherical surface 122a of the first universally-jointing portion 122, and so the second universally-jointing portion 124 has a smaller outer diameter. Since the rotating element 120 is supported on the base 110 by the second universally-jointing portion 124, thus the first universally-jointing portion 122 with a bigger outer diameter does not need to provide a function for supporting the rotating element 120, and so the first convex spherical surface 122a does not need to be designed to extend to the bottom of the first universally-jointing portion 122. In the embodiment, a shape of the first universally-jointing portion 122 is a truncated sphere. In more detail, the shape of the first convex spherical surface 122a of the first universally-jointing portion 122 is a sphere cutting an upper portion and a lower portion. As such, the height of the first universally-jointing portion 122 may be reduced, further reducing the overall volume, thereby saving the production cost and space.

In the embodiment, the first universally-jointing portion 122 has a concave 122b, and the second universally-jointing portion 124 is disposed in the concave 122b. In addition, the base 110 has an accommodating cavity 116, and the rotating element 120 is partially disposed in the accommodating cavity 116. The design of the concave 122b and the accommodating cavity 116 may effectively reduce the overall height of the structure. In further detail, the base 110 of the embodiment includes at least one universally-jointing block 110a (shown as two), and the first concave spherical surface 112 is formed on the universally-jointing block 110a. The universally-jointing block 110a is disposed on a side wall of the accommodating cavity 116, so the first universally-jointing portion 122 is suitable to be universally jointed to the first concave spherical surface 112 through the first convex spherical surface 122a. In addition, the base 110 further includes a support block 110b. The support block 110b is disposed on the bottom of the accommodating cavity 116, and the second concave spherical surface 114 is formed on the support block 110b, so the second universally-jointing portion 124 is suitable to be universally jointed to the second concave spherical surface 114 through the second convex spherical surface 124a.

In the embodiment, the rotating apparatus 100 further includes a fixing element 130. The base 110 includes a through hole 110c, and the through hole 110c is aligned to the universally-jointing block 110a. The fixing element 130 passes through the through hole 110c and is suitable to press the universally-jointing block 110a to the first universally-jointing portion 122, and fixes an angle of the rotating element 120 relative to the base 110. Furthermore, the angle of the rotating element 120 relative to the base 100 is depended on a height of the support block 110b (not shown). As such, the higher the support block, the larger the angle of the rotating element 120 relative to the base 100. Furthermore, the universally-jointing block 110a of the embodiment has a limit slot 110d, and an end of the fixing element 130 has a limit portion 132. The limit portion 132 is suitable to be inserted in the limit slot 110d, to stably press the universally-jointing block 110a to the first universally-jointing portion 122.

As shown in FIG. 3, the rotating apparatus of the embodiment further includes a testing platform 140. The testing platform 140 is disposed on the top of the first universally-jointing portion 122, wherein the user may dispose an object (not shown) on the testing platform 140, so that the object may rotate along the first universally-jointing portion 122 relative to the base 110. When the rotating apparatus 100 of the embodiment uses a medical ultrasound, the object may be, for example, an experimental living body (i.e. mouse). However, the invention is not limited thereto. The rotating apparatus 100 may be used to rotate other suitable objects to satisfy other requirements and purposes during an experiment. When assembling, the top of the first universally-jointing portion 122 may dispose an assembly portion 150, so the testing platform 140 is suitable to be assembled on the assembly portion 150 and fixed on the top of the first universally-jointing portion 122.

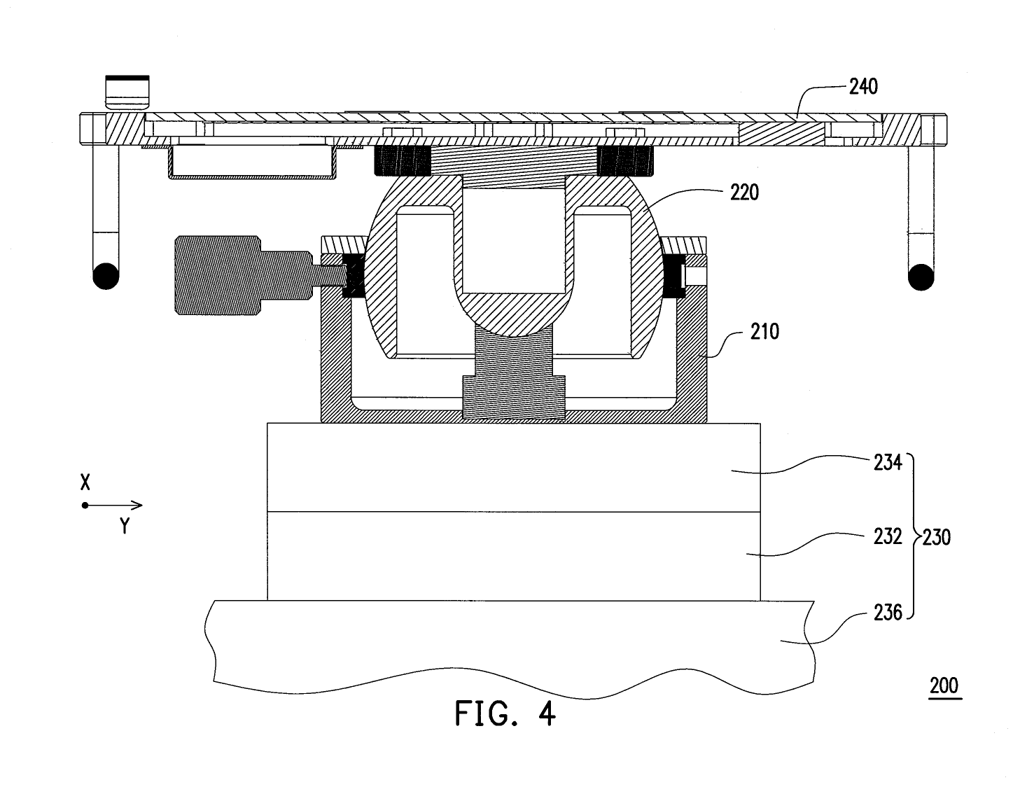

FIG. 4 is a cross-sectional view of part of the components of a rotating apparatus of another embodiment of the invention. Referring to FIG. 4, a rotating apparatus 200 of the embodiment has a base 210, a rotating element 220, and a shifting module 230. The configuration relationship and the actuating method of the base 210 and the rotating element 220 and the rotating apparatus 100 and the base 110 and the rotating element 120 are identical, and will not be repeated herein. The shifting module 230 includes a first moving element 232, a second moving element 234, and a fixed base 236. The first moving element 232 is slidably disposed on the fixed base 236 along an X direction (perpendicular to the direction of the surface of the paper). The second moving element 234 is slidably disposed on the first moving element 232 along a Y direction perpendicular to the X direction, and the base 210 is fixed on the second moving element 234. With this configuration method, the testing platform 240 fixed on the rotating element 220 may rotate along the rotating element 220 relative to the base 210, and may also move along the X direction and the Y direction as with the first moving element 232 and the second moving element 234 relative to the fixed base 236, having more actuating freedom.

Generally, in the embodiment of the invention, besides the rotating element being universally jointed to the base through the first universally-jointing portion, it is further universally jointed to the base through the second universally-jointing portion fixed on the bottom of the first universally-jointing portion, wherein the curvature radius of the second convex spherical surface of the second universally-jointing portion is smaller than the curvature radius of the first convex spherical surface of the first universally-jointing portion, so the second universally-jointing portion has a smaller outer diameter. Since the rotating element is supported on the base by the second universally-jointing portion, thus the first universally-jointing portion with a bigger outer diameter does not need to provide a function for supporting the rotating element, and so the first convex spherical surface does not need to be designed to extend to the bottom of the first universally-jointing portion. As such, the height of the first universally-jointing portion may be reduced, further reducing the overall volume, thereby saving the production cost and space.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A rotating apparatus, comprising:
a base, having a first concave spherical surface and a second concave spherical surface; and
a rotating element, comprising:
a first universally-jointing portion, having a first convex spherical surface, wherein the first universally-jointing portion is universally jointed to the first concave spherical surface through the first convex spherical surface; and
a second universally-jointing portion, fixed on the bottom of the first universally-jointing portion and has a second convex spherical surface, wherein a curvature radius of the second convex spherical surface is smaller than a curvature radius of the first convex spherical surface, the first convex spherical surface and the second convex spherical surface have the same curvature center, the second universally-jointing portion is universally jointed to the second concave spherical surface through the second convex spherical surface and supports the rotating element on the second concave spherical surface of the base.

2. The rotating apparatus as claimed in claim 1, wherein the first universally-jointing portion has a concave, and the second universally-jointing portion is disposed in the concave.

3. The rotating apparatus as claimed in claim 1, wherein the base has an accommodating cavity, the rotating element is partially disposed in the accommodating cavity.

4. The rotating apparatus as claimed in claim 3, wherein the base comprises at least one universally-jointing block, the first concave spherical surface forms on the universally-jointing block, the universally-jointing block is disposed on a side wall of the accommodating cavity.

5. The rotating apparatus as claimed in claim 4, further comprising:
a fixing element, the base comprises a through hole, the through hole is aligned to the universally-jointing block, the fixing element passes through the through hole and is suitable to press the universally-jointing block on the first universally-jointing portion to fix the rotating element.

6. The rotating apparatus as claimed in claim 5, wherein the universally-jointing block has a limit slot, an end of the fixing element has a limit portion, the limit portion is suitable to be inserted in the limit slot.

7. The rotating apparatus as claimed in claim 3, wherein the base comprises a support block, the support block is disposed on the bottom of the accommodating cavity, the second concave spherical surface is formed on the support block.

8. The rotating apparatus as claimed in claim 7, wherein an angle of the rotating element relative to the base is depended on a height of the support block.

9. The rotating apparatus as claimed in claim 1, further comprising:
a testing platform, disposed on the top of the first universally-jointing portion, wherein an object is suitable to be disposed on the testing platform and rotate along the first universally-jointing portion relative to the base.

10. The rotating apparatus as claimed in claim 9, further comprising:
an assembly portion, fixed on the top of the first universally-jointing portion, wherein the testing platform is assembled on the assembly portion.

11. The rotating apparatus as claimed in claim 1, further comprising a shifting module, the shifting module comprising:
a fixed base;
a first moving element, slidably disposed on the fixed based along a first direction; and
a second moving element, slidably disposed on the first moving element along a second direction perpendicular to the first direction, wherein the base is fixed on the second moving element.

12. The rotating apparatus as claimed in claim 1, wherein a shape of the first universally-jointing portion is a truncated sphere.
